(19) United States
(12) Patent Application Publication
(10) Pub. No.: US 2020/0140331 A1
(43) Pub. Date: May 7, 2020

(54) METHOD TO PRODUCE TYPE F, C AND N POZZOLIN FLY ASH FROM A FLUIDIZED BED BOILER

(71) Applicant: Q Power LLC, Pittsburgh, PA (US)

(72) Inventor: Jeffrey Campbell, Butler, PA (US)

(73) Assignee: Q Power LLC, Pittsburgh, PA (US)

(21) Appl. No.: 16/595,984

(22) Filed: Oct. 8, 2019

Related U.S. Application Data
(60) Provisional application No. 62/756,336, filed on Nov. 6, 2018.

(51) Int. Cl. C04B 7/26; C04B 7/42; C04B 7/44; F23J 1/00; F23J 3/06

(52) U.S. Cl. CPC C04B 7/26; C04B 7/425; F23J 3/06; F23J 1/00; C04B 7/4407

(57) ABSTRACT

A process for producing fly ash in a fluidized bed boiler includes combusting a fuel in a fluidized bed combustor in the presence of limestone particles, recovering fly ash, and recovering bottom ash. The fuel contains hydrocarbons and sulfur. A majority of the sulfur from the fuel is recovered from the bottom ash. The fly ash may contain less than 5% by weight of sulfur oxides. This may be achieved by using limestone particles having certain properties and/or narrowing an inlet from the boiler into a cyclone.

The present application claims priority to Provisional Patent Application Ser. No. 62/756,336, filed Nov. 6, 2018, which is incorporated by reference herein in its entirety.

### BACKGROUND OF THE DISCLOSURE

Circulating Fluidized Bed Boilers (CFB) are modern power boilers designed with low (e.g., 1600° F.) flame temperature and integrated fuel sulfur scrubbing using limestone (CaCO₃) for low NOx and SO₂ emissions. Since these boilers use solid particle conduction for heat transfer they require high ash waste fuel to maintain proper heat transfer and combustion temperatures. The boilers also require a powdered limestone feed to capture sulfur (and contribute to the solids conduction in the combustor). The low fuel quality results in very high ash flows from the boilers.

It is desirable to eliminate sulfur oxide emissions. Sulfur contained in the fuel is typically converted into sulfur dioxide (SO₂) during combustion. At least a portion (e.g., 10%) of this SO₂ can be oxidized to sulfur trioxide (SO₃) at low temperatures. SO₂ and SO₃ may be collectively referred to as sulfur oxides or SOₓ. SO₃ can react with water to form sulfuric acid (H₂SO₄), which is a highly corrosive agent to heat exchange surfaces and an undesirable stack emission.

Hot ash is separated from the flue gas and circulated back into the combustor for extremely high carbon burnout of the low quality fuel. Finely ground limestone is pneumatically injected into the boilers and calcined to Calcium Oxide (CaO) in the furnace by the heat released from combusting coal. The resulting CaO is used to capture sulfur to form calcium sulfate (CaSO₄).

The boilers are designed to have limestone ground very fine to give maximum surface area to volume ratio to maximize particle sulfadation. As the limestone particles decrease in size finer than 200 mesh in the circulating loop it moves past the cyclone separator to the baghouse in the form of CaSO₄.

Ash is delivered to either a fine fly ash baghouse collector or a coarse bottom ash drain in the boilers. Boiler airflow dictates the cut size between bottom and fly ash size; there is very little overlap between bottom and fly ash sizing due to the boiler air classification. Both ash streams are primarily comprised of intermingled coal ash (silica, alumina, iron chemistry) and limestone ash (e.g., CaSO₄, CaO, unreacted CaCO₃).

The problem with generating Cement grade fly ash in the existing CFB design is that the integrated scrubbing and (relatively) low combustion temperatures result in an ash with very high sulfur content and high non-carbon Loss on Ignition (LOI) as a result of fine limestone (CaCO₃) particles not being fully calcined to CaO in the boiler due to short residence times in the calcine region of the combustor.

The cyclone separators on the boilers are typically 99% efficient, but due to the extremely high circulating rate in the units the 1% slip causes fly ash to have more than 34% material retained on a 325 mesh screen. The net effect is that CFB ash is generally considered unsuitable for ASTM-C 618 fly ash for SO₃, LOI and/or fineness.

Thus, there is a need for a process to inexpensively modify limestone feedstock and internal configuration of a CFB to maintain the desirable integrated scrubbing and low NOx of a CFB while generating ash streams that meet ASTM standards for fineness, SO₃, and LOI for Class F, Class C, or Class N type pozzolin fly ash.

### SUMMARY OF THE DISCLOSURE

The disclosure relates to producing fly ash. More particularly, it relates to a method to produce type F, C and N pozzolin fly ash from a circulating fluidized bed boiler (CFB).

In accordance with a preferred embodiment of the present disclosure, a modified limestone grind can be pneumatically conveyed or pre-mixed with the coal feedstock for the plant and allows it to exceed design specifications for sulfur capture while concentrating the sulfur in the bed ash (rather than in existing designs which direct limestone to circulating solids and fly ash size). Bed ash is then conditioned through a secondary process to further reduce sulfur.

In accordance with another aspect of the disclosure, Loss On Ignition (LOI) is weight loss resulting from gases driven from a solid material sample due to heating. In the present disclosure this weight loss is comprised of carbon conversion to CO₂ (G), CaCO₃ conversion to CaO+CO₂ (G) and moisture losses (insignificant moisture in fly ash). Carbon losses are less than the 6% allowed in class A & F fly ash, but due to the integrated scrubbing there is non-carbon LOI in the fly ash coming from fine limestone in the fly ash. The process of the present disclosure reduces the non-carbon LOI by moving the limestone grind to the bed.

Existing CFB cyclones are designed to recycle enough solids to maintain heat transfer in the combustor, but no particular attention is paid to cut size on the cyclones because it is not needed for power production. In accordance with another aspect of the disclosure, a method to increase cyclone efficiency and produce a finer fly ash is to increase the velocity out of the combustor and into the cyclone by narrowing the inlet (e.g., by about 5% to about 20%, including from about 10% to about 15% and 12%). The higher velocity resulting from that nozzle increases efficiency and produces a finer ash.

In accordance with another aspect of the disclosure, the process of the present disclosure is designed to generate a type C, F or N pozzolin fly ash from a circulating fluid bed boiler (CFB) without the undesirable sulfur, LOI or coarse fly ash typical of existing fluid bed boilers.

Disclosed, in some embodiments, is a method for producing a fly ash including: feeding a fuel to a fluidized bed combustor, the fuel comprising hydrocarbons and sulfur; feeding limestone particles to the fluidized bed combustor; combusting the fuel in the fluidized bed combustor to produce a flue gas; recovering a bottom ash from the fluidized bed combustor; and recovering a fly ash from the fluidized bed combustor. The fly ash comprises less than 5% by weight of SO₃.

In some embodiments, the limestone particles injected into the boiler have a D50 in the range of from about 500 microns to about 700 microns, including from about 550 microns to about 650 microns, from about 575 microns to about 615 microns, from about 585 microns to about 605 microns, and about 595 microns. In some embodiments, from about 90% to about 98% pass 2000 microns and/or from about 5% to about 15% pass 210 microns. In particular embodiments, the particles have a D50 of 595 microns, 95% passing 2000 microns and 10% passing 210 microns. The limestone mixed with incoming fuel meets a standard #10 aggregate size specification

The flue gas produced in the fluidized bed combustor may be fed to a recycle device through an inlet; and the inlet may have a cross-sectional area which decreases in the direction of the recycle device.

In some embodiments, the cross-sectional area is decreased by a bullnose modification to the inlet.

The inlet may include a steam injector and a steam blanket.

In some embodiments, the recycle device is a cyclone.

Optionally, the method further includes: separating the bottom ash into Ca(OH)₂ and lightweight aggregate.

The fly ash may be recovered in a baghouse.

In some embodiments, the flue gas passes through superheater and economizer sections before reaching the baghouse.

A Ca(OH)₂ slurry may be injected into flue gas.

Optionally, the method further includes feeding clay to the fluidized bed combustor.

In some embodiments, the hydrocarbons and the limestone are fed to the fluidized bed combustor together. Alternatively, the hydrocarbons and the limestone are fed to the fluidized bed combustor separately.

In some embodiments, the limestone particles are sized small enough to have an efficient surface area to volume ratio for sulfur capture while also being sized large enough to prevent the majority of the limestone from reporting to the flyash stream. the flue gas produced in the fluidized bed combustor is fed to a recycle device through an inlet; and the inlet has a cross-sectional area which decreases in the direction of the recycle device.

Disclosed, in other embodiments, is a system for producing fly ash. The system includes a fluidized bed combustor comprising a fuel inlet, a recycle inlet, and a boiler outlet; and a recycle device comprising a device inlet connected to the boiler outlet, a recycle outlet connected to the recycle inlet, and a flue gas outlet. The recycle inlet has a cross-sectional area which decreases in the direction of the recycle device.

The recycle device may be a cyclone.

In some embodiments, the system further includes a steam injector and a steam blanket in the recycle inlet.

The recycle inlet may include a bullnose modification.

In some embodiments, the system further includes a baghouse in fluid communication with the flue gas outlet for recovering low-sulfur fly ash.

Disclosed in further embodiments, is a cyclone separator device including an inlet. The inlet includes a bullnose modification, a steam injector, and a steam blanket, Across-sectional area of the inlet decreases with increasing depth into the inlet.

Other aspects of the disclosure will become apparent upon a reading and understanding of the following detailed description.

### BRIEF DESCRIPTION OF THE DRAWINGS

FIG. 1 is a chart illustrating recommended limestone via the process of the present disclosure.

FIG. 2 is a chart illustrating Ca/S ratio vs. mesh.

FIG. 3 is an enlarged cross-sectioned view of a modified bullnose of a combustor assembly in accordance with a preferred embodiment of the disclosure.

FIG. 4 is a flow chart illustrating flow paths of a bottom ash lime recovery system.

FIG. 5 is a graph illustrating surface area:volume ratio as a function of particle size.

### DETAILED DESCRIPTION OF THE DISCLOSURE

The present disclosure may be understood more readily by reference to the following detailed description of desired embodiments included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the particular value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The term fluidization refers to a condition in which solid materials are given free-flowing, fluid-like behavior. As a gas is passed upward through a bed of solid particles, the flow of gas produces forces which tend to separate the particles from one another. At low gas flows, the particles remain in contact with other solids and tend to resist movement. This condition may be referred to as a fixed bed condition. As the gas flow rate is increased, a point is reached at which the forces on the particles are just sufficient to cause separation. The bed then becomes fluidized. The gas cushion between the solids allows the particles to move freely, thereby giving the bed a liquid-like characteristic. Fluidized-bed combustion can burn hydrocarbons (e.g., coal) efficiently at a temperature sufficiently low to avoid ash slagging and NOx formation from combustion in other modes.

As used herein, the term “D50”, also known as the “mass median diameter”, refers to the particle diameter at which 50% of a sample's mass is comprised of smaller particles.

The present disclosure relates to a process to inexpensively modify the limestone feedstock and/or the internal configuration of a circulating fluidized bed (CFB) boiler to maintain the desirable integrated scrubbing and low NOx of a CFB while generating ash streams that meet ASTM standards for fineness, SO₃, and LOI for Class F, Class C, or Class N type pozzolin fly ash. In some embodiments, the LOI is less than 5%.

The fly ash may be classified according to ASTM-C 618. Class N fly ash may refer to raw or calcined natural pozzolans such as some diatomaceous earths, opaline chert and shale, stuffs, volcanic ash, pumice, calcined kaolin clay, and lateritic shale. Class F flay ash may refer to fly ash produced from burning anthracite or bituminous clay. Class F fly ash exhibits pozzolanic properties but little or no self-hardening. Class C fly ash may refer to fly ash produced from lignite or sub-bituminous coal. The class C fly ash may contain at least 10 wt % CaO or at least 15 wt % CaO.

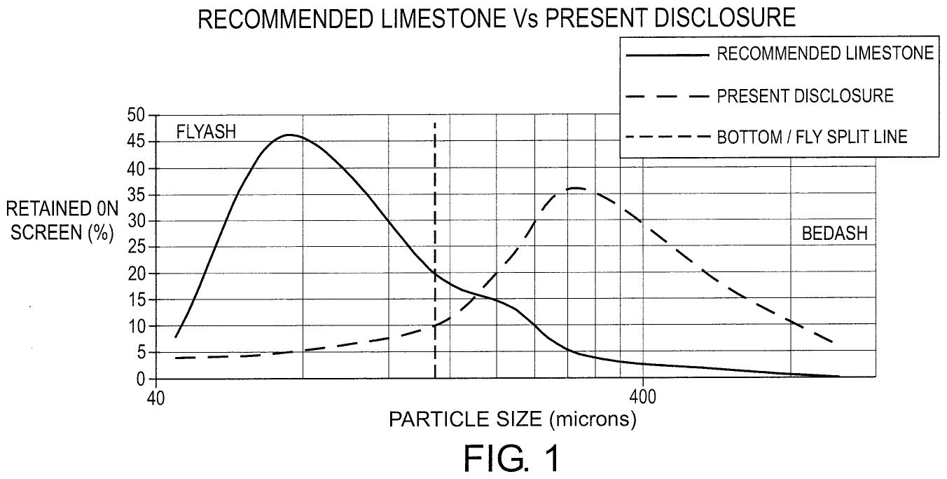

One aspect of the disclosure is it addresses sulfur, fineness and LOI in a method contrary to the published targets for limestone and cyclone geometry. Referring to FIG. 1, a chart shows the industry standard grind profile versus the process limestone grind according to some embodiments of the present disclosure. The dotted line shows the size threshold between bottom and fly ash.

Referring still to FIG. 1, a review of the curve places the majority of limestone in the fly ash whereas the process of the present disclosure directs the majority of limestone to bottom ash. Therefore, this grind solves the inherent CFB fly ash sulfur and LOI problem.

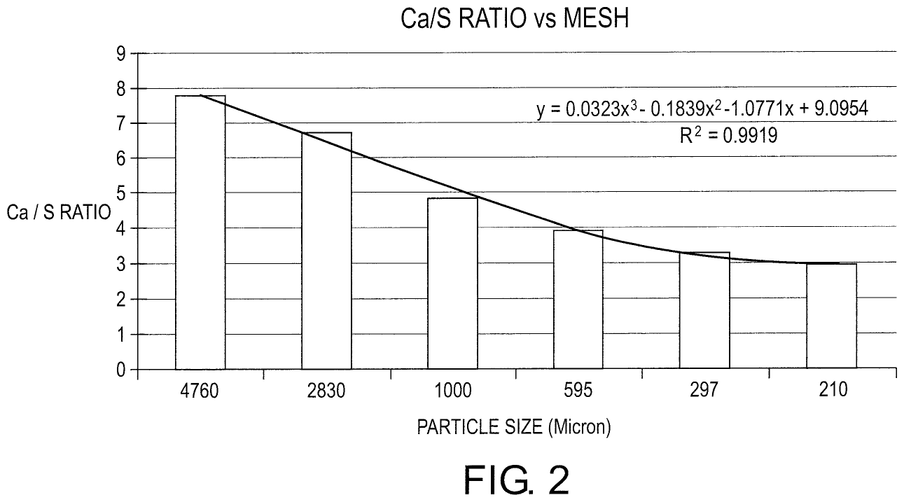

Only the surface of the limestone particles is available for sulfur capture so industry standard is to maximize the surface area to volume ratio of the limestone to maximize its utilization. The chart shown in FIG. 2 illustrates typical limestone utilization vs size.

The smaller the particle and the higher the surface area to volume ratio, the closer to the ideal 1:1 Ca/S (Calcium to Sulfur) ratio is achieved. The industry curve targets the smallest particles to optimize limestone usage, but that target curve results in 100% sulfur reporting to fly ash.

The process of the preferred embodiment of the present disclosure will yield slightly lower limestone utilization due to less ideal surface area to volume ratio (not ideal for optimizing steam generation), but that lower surface area to volume allows directing sulfur to bottom ash instead of fly ash. Sulfur can then be easily refined out of the bottom ash at a later stage.

The remaining fineness deficiency is addressed through a combination of cyclone inlet geometry modifications, steam jacketing and fine material injection as needed.

The process of the present disclosure uses a modified cyclone inlet in conjunction with a water spray blanket that can be modulated on and off to further increase or decrease velocity into the cyclone.

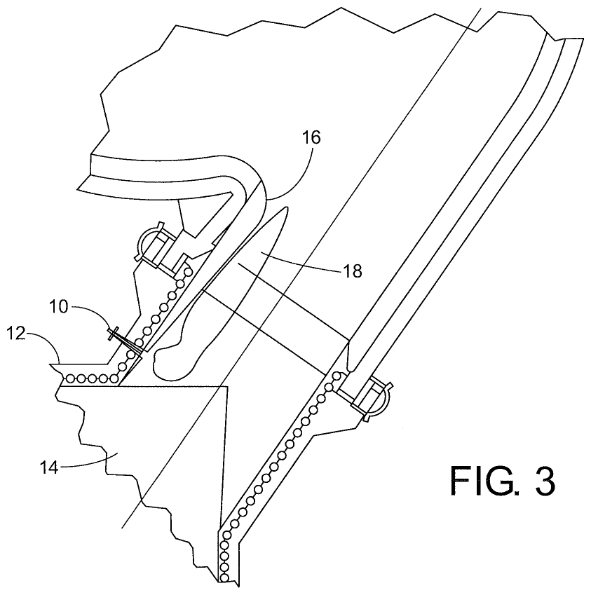

Specifically, referring now to FIG. 3, water is sprayed in a fine mist at a cyclone inlet 10 on an inboard wall 12 of a combustor 14 in accordance with a preferred embodiment of the present disclosure. As this fine water spray flashes to steam it vastly increases in volume. That additional volume creates a pocket of steam that further increases velocities into the cyclone and increases the efficiency thus improving the fineness of the resulting fly ash. This water spray is not commonly employed because fine ash is not needed for power or steam generation. FIG. 3 further illustrates a bullnose modification 16 of combustor 14 and steam blanket 18 used to increase velocity into the cyclone. This additional velocity increases cyclone efficiency to control fly ash fineness as needed.

Regarding the bullnose modification, by decreasing the cross-sectional area while maintaining the same fluegas volume, velocity through the nozzle can be increased. The introduction of the steam blanket against the inner wall may lead to the injected water flashing to steam and add additional volume which must pass through the nozzle thereby providing a further increase in velocity for the combined fluegas/steam volume. Modulation of water flow allows dynamic control of the velocity without the need for physical changes to wall geometry. Therefore, a high temperature variable cross-section nozzle can be achieved with no moving parts. Flows in this region are fairly laminar so introducing the steam mass on the inboard wall forces the existing fluegas/ash stream to concentrate closer to the outboard wall where boundary layer effects drop the fluegas velocity and allow ash to drop out of the fluegas stream and be re-injected into the boiler.

The last stage in the process of the present disclosure is lime recovery in the bottom ash. The process outlined above creates a high concentration of both Calcium Oxide and sulfur co-mingled with silica, alumina, and iron ash from the coal in the bottom ash stream. The calcium particles are similar in size and density to the other Si, Al and Fe particles so they cannot be density or size separated. CaO particle size can however be chemically altered through hydration.

The process of the present disclosure uses conventional aggregate wet screening equipment in conjunction with concepts from wet scrubbing slaking apparatus to hydrate the CaO particles in the bottom ash to calcium hydroxide Ca(OH)₂, separate those particles from the surrounding Si, Al & Fe particles and either re-inject Ca(OH)₂ in the boiler for either additional sulfur capture or HCl capture (depending on re-injection point). The elevated temperature of the boiler returns Ca(OH)₂ to CaO in the fly ash. The end result is a washed aggregate suitable for construction and a Calcium product that can be used to augment fineness without the sulfur or LOI penalty commonly experienced in the CFB.

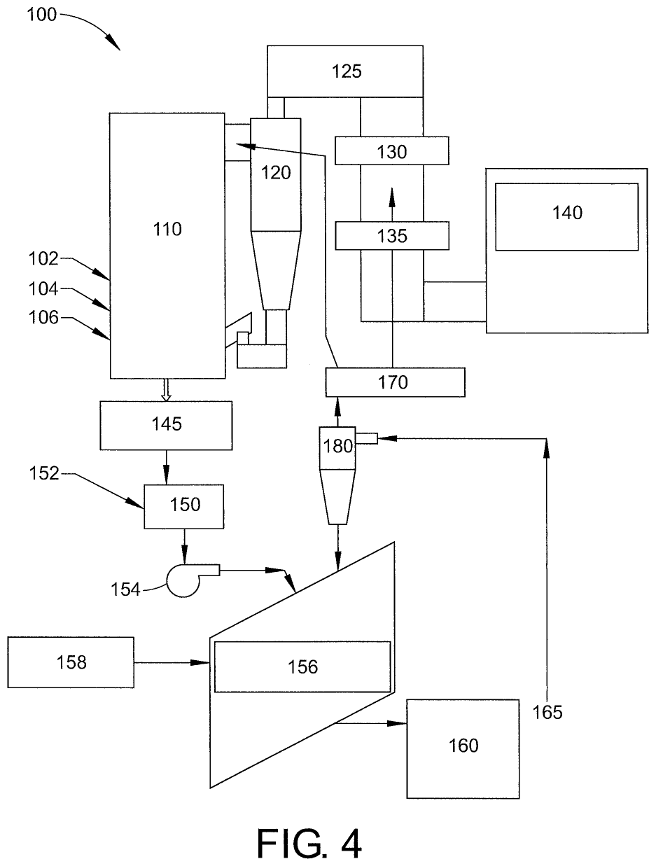

The diagram in FIG. 4 illustrates the various flowpaths in the bottom ash lime recovery system of the present disclosure. In FIG. 4, reference numerals designate the various elements of the system 100 as follows:

102—hydrocarbon (e.g., coal) feed;

104—limestone feed;

106—clay feed;

110—fluidized bed combustor;

120—recycle device (e.g., cyclone);

125—superheater;

130—economizer;

135—air heater;

140—fly ash collection device (e.g., baghouse);

145—bottom ash stream;

150—slurry tank;

152—makeup water;

154—pump;

156—particle size separator (e.g., vibrating screen deck—optionally 100 mesh cut);

158—lightweight aggregate;

160—hydrated calcium oxide (Ca(OH)₂);

165—diluted suspension of Ca(OH)₂ in water;

170—Ca(OH)₂ slurry; and

180—hydrocyclone concentrator.

It should be understood that not all features of the boiler system are illustrated. For example, air and/or oxygen feeds are omitted.

The limestone:coal weight ratio fed to the system may be in the range of about 10% to about 50%, including from about 20% to about 40%, about 25% to about 35%, and about 30%.

The clay:coal weight ratio fed to the system may be in the range of about 1% to about 20%, including from about 3% to about 18%, form about 5% to about 15%, from about 8% to about 12%, and about 10%.

Fluidized combustion of coal involves the burning of coal particles in a hot fluidized bed of noncombustible particles (e.g., limestone). Once the coal is fed into the bed, it is rapidly dispersed throughout the bed as it burns. The bed temperature can be controlled via heat exchanger tubes. Elutriation is responsible for the removal of the smallest solid particles and larger solid particles can be removed through bed drain pipes. To increase combustion efficiency, elutriated particles from the bed can be collected in a cyclone and re-injected into the fluidized bed.

In the combustor, limestone (CaCO₃) may be calcined into carbon dioxide (CO₂) and calcium oxide (CaO; also known as burnt lime). The burnt lime can then react with sulfur oxides to produce calcium sulfate (CaSO₄).

The recycle/recirculation device may be a cyclone. Cyclonic separation is a method for removing particulates from a gas e.g., flue gas) stream through vortex separation. Rotational effects and gravity are used to separate mixtures of materials. A high speed rotating gas flow is generated within the cyclone and the gas flows in a helical pattern, beginning at a wider end and ending at a narrower end before flowing up and out of the top. Larger particles have too much inertia to follow the gas steam. In some embodiments, these larger particles strike the wall of the cyclone and fall to the bottom where they can be recycled or recirculated to the combustor. Particles larger than a “cut point” will be removed more efficiently and smaller particles may follow the gas stream for further processing (e.g., collection in a baghouse or other collection device.

In some embodiments, the limestone is recirculated to into the combustor for more than 5 minutes to achieve full calcination.

In some embodiments, the SO₃ content in the fly ash is less than 5 wt %.

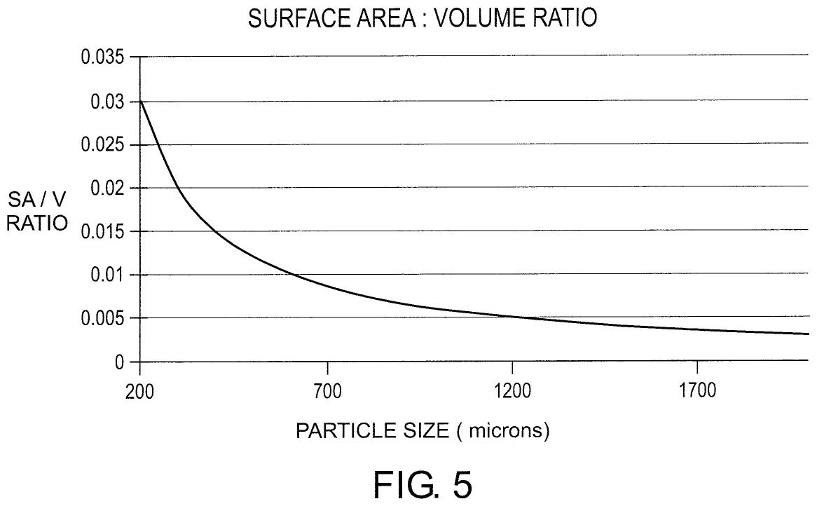

FIG. 5 is a graph illustrating surface area:volume ratio as a function of particle size. The surface area (SA) of a sphere is 4πr² where r is the radius. The volume (V) of a sphere is (4πr³)/3. Therefore, the SA:V ratio simplifies to SA:V=3/r. Increasing the numerator and decreasing the denominator (smaller particles) may be beneficial.

Non-limiting examples of hydrocarbons suitable for combustion in the systems and methods of the present disclosure include coal (e.g., pulverized coal), oil, and natural gas.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the above disclosures or the equivalents thereof.

1. A method for producing a fly ash comprising:
feeding a fuel to a fluidized bed combustor, the fuel comprising hydrocarbons and sulfur;
feeding limestone particles to the fluidized bed combustor;
combusting the fuel in the fluidized bed combustor to produced a flue gas;
recovering a bottom ash from the fluidized bed combustor; and
recovering a fly ash from the fluidized bed combustor;
wherein the fly ash comprises less than 5% by weight of sulfur oxides.

2. The method of claim 1, wherein the limestone particles have a D50 in the range of from about 550 microns to about 650 microns.

3. The method of claim 1, wherein the flue gas produced in the fluidized bed combustor is fed to a recycle device through an inlet; and wherein the inlet has a cross-sectional area which decreases in the direction of the recycle device.

4. The method of claim 4, wherein the cross-sectional area is decreased by a bullnose modification to the inlet.

5. The method of claim 4, wherein the inlet comprises a steam injector and a steam blanket.

6. The method of claim 4, wherein the recycle device is a cyclone.

7. The method of claim 1, further comprising:
separating the bottom ash into Ca(OH)₂ and lightweight aggregate.

8. The method of claim 1, wherein the fly ash is recovered in a baghouse.

9. The method of claim 8, wherein the flue gas passes through superheater and economizer sections before reaching the baghouse.

10. The method of claim 1, wherein a Ca(OH)₂ slurry is injected into flue gas.

11. The method of claim 1, further comprising:
feeding clay to the fluidized bed combustor.

12. The method of claim 1, wherein the hydrocarbons and the limestone are fed to the fluidized bed combustor together.

13. The method of claim 1, wherein the hydrocarbons and the limestone are fed to the fluidized bed combustor separately.

14. The method of claim 1, wherein the limestone particles have a D50 in the range of from about 550 microns to about 650 microns; wherein the flue gas produced in the fluidized bed combustor is fed to a recycle device through an inlet; and wherein the inlet has a cross-sectional area which decreases in the direction of the recycle device.

15. A fluidized bed boiler system for producing fly ash comprising:
a fluidized bed combustor comprising a fuel inlet, a recycle inlet, and a boiler outlet; and
a recycle device comprising a device inlet connected to the boiler outlet, a recycle outlet connected to the recycle inlet, and a flue gas outlet;
wherein the recycle inlet has a cross-sectional area which decreases in the direction of the recycle device.

16. The system of claim 15, wherein the recycle device is a cyclone.

17. The system of claim 15, further comprising:
a steam injector and a steam blanket in the recycle inlet.

18. The system of claim 15, wherein the recycle inlet comprises a bullnose modification.

19. The system of claim 15, further comprising:
a baghouse in fluid communication with the flue gas outlet for recovering low-sulfur fly ash.

20. A cyclone separator device comprising an inlet, wherein the inlet comprises a bullnose modification, a steam injector, and a steam blanket; and wherein a cross-sectional area of the inlet decreases with increasing depth into the inlet.
